(19) United States
(12) Patent Application Publication
(10) Pub. No.: US 2023/0099380 A1
(43) Pub. Date: Mar. 30, 2023

(54) POWER TRANSMISSION BELT WITH TEXTILE SURFACE LAYER AND METHODS OF MAKING THE SAME

(71) Applicant: GATES CORPORATION, Denver, CO (US)

(72) Inventors: Douglas G. Gerring, Denver, CO (US); Young W. Desanti, Gilbert, AZ (US); Karla J. Bier, Columbia, MO (US); Shawn Xiang Wu, Rochester Hills, MI (US)

(21) Appl. No.: 17/948,179

(22) Filed: Sep. 19, 2022

Related U.S. Application Data
(60) Provisional application No. 63/250,798, filed on Sep. 30, 2021.

(51) Int. Cl. F16G 1/08; B29C 43/00; D04B 1/22; D04B 1/18; D04B 21/20; F16G 1/28

(52) U.S. Cl. CPC F16G 1/08; B29C 43/003; D04B 1/22; D04B 1/18; D04B 21/20; F16G 1/28; D10B 2505/02; D10B 2201/02; D10B 2331/10; B29L 2031/7094

(57) ABSTRACT

belts and methods of manufacturing the same are described herein. The belt generally includes a base layer having a plurality of surface features (e.g., ribs or teeth) formed on a front surface of the base layer, and a stretched surface layer disposed on and conforming to the surface features. The stretched surface layer may comprise a knit fabric material that is from about 3 to about 10 wt. % elastomeric fiber or yarn and from about 90 to about 97 wt. % non-elastomeric yarn or fiber. The stretched surface layer is stretched over the front surface of the base layer such that the surface density of the stretched surface layer on the front surface is from about 100 to about 150 g/m². Manufacturing methods for producing the belt with stretched surface layer generally includes disposing the surface layer on a planar front surface of the base layer and pressing a mold into the front surface of the base layer to thereby form a plurality of surface features in the front surface of the base layer. The molding step is carried out such that surface density of the surface layer on the front surface is in the range of from about 100 to about 150 g/m² and such that the surface layer is stretched in at least two directions.

### TECHNICAL FIELD

The present application relates to belts for use in, for example, power transmission, and more specifically, to belts having a stretched textile surface layer for providing improved noise reduction, abrasion resistance, and coefficient of friction (COF) in wet and dry conditions without sacrificing other belt performance characteristics such as flexibility, bending stiffness, wear, and power transmission.

### BACKGROUND

In the field of belts for use in, for example, power transmission, noise reduction, and improved abrasion resistance and coefficient of friction (COF) are highly desired performance characteristics. However, various known means for improving these characteristics may negatively impact other performance characteristics of the belt, such as, but not limited to, energy efficiency, flexibility and durability. Other factors that may be impacted when attempting to improve noise reduction, abrasion resistance and COF include ease of manufacturing processing and costs. That is to say, various techniques may be known for improving noise reduction, abrasion resistance and COF, but if these techniques require complicated processing techniques, expensive processing techniques, and/or highly specialized tooling, then the techniques are generally not acceptable for use in commercial settings.

Accordingly, a need exists for belts and associated manufacturing methods that provide improved noise reduction, abrasion resistance and COF without sacrificing other belt performance characteristics and which can be manufactured at relatively low cost using relatively simple processing techniques that do not require special tooling.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a belt is described, the belt including a base layer having a back surface and a front surface opposite the back surface, wherein the front surface is in the form of a plurality of surface features, and a stretched surface layer disposed on the front surface of the base layer, the stretched surface layer conforming to the surface features. The stretched surface layer includes a knit fabric material, the knit fabric material comprising from about 3 to about 10 wt. % elastomeric yarn or fiber and from about 90 to about 97 wt. % non-elastomeric fiber or yarn. The stretched surface layer is stretched over the front surface of the base layer such that the surface density of the stretched surface layer on the front surface is from 100 to 150 g/m². In some embodiments, the belt can be, e.g., a synchronous belt, a V-belt or a micro-V belt, a flat belt, or any other power transmission belt.

In other embodiments, a method of manufacturing a belt is described, the method including the steps of disposing a surface layer on a planar front surface of a base layer, and pressing a mold into the front surface of the base layer to thereby form a plurality of surface features in the front surface of the base layer. The step of pressing the mold into the front surface of the base layer is carried out such that the surface layer is stretched to conform to the surface features formed in the front surface of the base layer, the surface density of the surface layer of the front surface is in the range of from 100 to 150 g/m², and the surface layer is stretched in at least two directions.

These and other aspects of the high efficiency belt described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed high efficiency belt, including the preferred embodiment, are described with reference to the following figures, wherein like reference numerals refer to like parts throughout the various views unless otherwise specified.

FIG. 1 a cross-sectional view of a belt including a stretched surface layer in accordance with various embodiments described herein.

FIG. 2 is a flow chart illustrating a method for manufacturing a belt in accordance with various embodiments described herein.

FIG. 3 is a graph of the elongation curve for stretching surface layer materials used in accordance with the various embodiments described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

The belt described herein may be similar or identical to various aspects of to the high efficiency belt described in U.S. Patent Application Publication No. 2021/0062892, the entirety of which is hereby incorporated by reference.

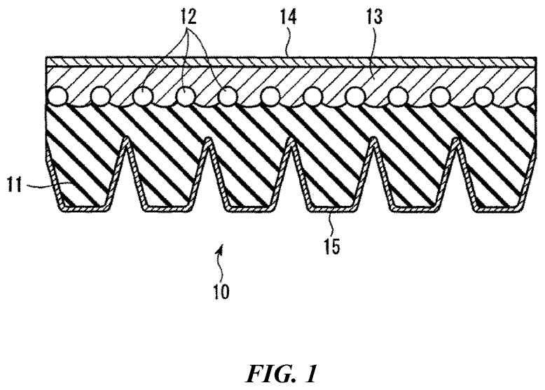

With reference to FIG. 1, a cross sectional view of a belt 10 configured in accordance with various embodiments described herein is shown. Belt 10 generally includes a backing layer 14, an adhesion layer 13, cords 12, a base layer 11, and a surface layer 15. The belt can be, e.g., a synchronous belt, a V-belt or a micro-V belt, a flat belt, or any other power transmission belt. As shown in FIG. 1, belt 10 includes a plurality of ribs formed in the front surface of the base layer 11, but it should be appreciated that the front surface of base layer 11 may include any type of surface feature, including ribs, grooves, teeth, or other types of surface features that may be suitable for use in a belt of the type described herein. Similarly, the specific dimensions, shapes and number of surface features included on the front surface of base layer 11 are generally not limited except to the extent noted below.

With respect to base layer 11, which may be referred to as a rib layer when the surface features formed therein are ribs, the material of the base layer 11 generally includes one or more rubber stock materials. Exemplary suitable rubber stock materials include, but are not limited to, natural rubber, styrene-butadiene rubber (SBR), chloroprene rubber (CR), ethylene propylene elastomers (EPDM and EPM) and other ethylene-elastomer copolymers such as ethylene butene (EBM), ethylene pentene and ethylene octene (EOM), hydrogenated nitrile butadiene rubber (HNBR), and fluoroelastomers (FKM).

In addition to rubber stock materials, the base layer may further include materials such as reinforcement material, fillers, oils and/or curatives. With respect to reinforcement material, the base layer 11 may include chopped fiber segments, though other reinforcement material can also be used. When chopped fibers are used, the chopped fibers may be, for example, aramid, polyester (PET), cotton, or nylon. The chopped fibers may be made from either natural or man-made material, or a mixture of natural and man-made materials. The chopped fiber material may also be in the form of carbon fiber nanotubes. The dimensions of the chopped fibers used in the base layer 11 are generally not limited. In some embodiments, the reinforcement material is high aspect ratio material having a length in the range of from 0.2 mm to 3 mm. In some embodiments, the reinforcement materials (e.g., chopped fibers) have an aspect ratio of from 10 to 250.

With respect to the fillers, some embodiments of the belt described herein use carbon black as the filler material, though other filler can be used, either alone or in conjunction with carbon black. Other fillers suitable for use in base layer 11 include, but are not limited to clays, pulps and silicas.

With respect to the oil, the oil as a raw ingredient is generally provided as the liquid or binder material that allows for the mixing together of the other dry ingredients and the formation of a thick mixture that can be formed into the base layer 11. Any suitable oil can be used, including, but not limited to, aromatic, naphthenic, and paraffinic.

With respect to curatives, any suitable curative material can be used. Exemplary curatives suitable for use in base layer 11 include, but are not limited to, sulfur and peroxides.

In some embodiments, the amount of rubber stock used in base layer 11 is from 30 wt. % to 70 wt. % of the total weight of the mixed composition prepared in the formation of the base layer 11. In some embodiments, the rubber stock is from about 40 wt. % to 60 wt. % of the total weight of the mixed composition. In some embodiments, the amount of reinforcement material (e.g., chopped fiber) used in base layer 11 is from 2 wt. % to 30 wt. % of the total weight of the mixed composition. In some embodiments, the reinforcement material is from about 6 wt. % to about 14 wt. % of the total weight of the mixed composition. In some embodiments, the amount of filler used in base layer 11 is from 5 wt. % to 45 wt. % of the total weight of the mixed composition. In some embodiments, the filler is from about 10 wt. % to about 20 wt. % of the total weight of the mixed composition. In some embodiments, the amount of oil used in base layer 11 is from 2 wt. % to 18 wt. % of the total weight of the mixed composition. In some embodiments, the oil is from about 2 wt. % to about 8 wt. % of the total weight of the mixed composition. In some embodiments, the amount of curative used in base layer 11 is less than about 8 wt. % of the total weight of the mixed composition, such as less than 5 wt. %.

The surface layer 15 disposed on the front surface of the base layer 11 generally conforms to the surface features formed on the base layer 11 such that the surface layer abuts the base layer 11 throughout the front surface of the of base layer 11, including in the valleys of the ribs or other surface features formed in the front surface of base layer. As described in greater detail below, the manner in which the belt 10 is constructed, and more specifically, the manner in which the surface features are formed in the front surface of the base layer 11, ensures that the surface layer 15 conforms to the surface features throughout the front surface of the base layer 11.

In some embodiments, the material of the surface layer is a stretchable knit fabric material. The fabric can be constructed using weft, warp, or other known knitting processes. In some embodiments, the knit fabric material comprises at least one non-elastomeric yarn or fiber (such as but not limited to, cellulose-based material, and nylon), and at least one elastomeric or texturized yarn or fiber (such as but not limited to interlocked yarn, rubber yarn, and polyurethane yarn or filament). Any combination of non-elastomeric materials at any ratio can be used when the surface layer includes more than one type of non-elastomeric material. Any combination of elastomeric material at any ratio can be used when the surface layer includes more than one type of elastomeric material. When the non-elastomeric yarn fiber includes a cellulose-based material, the specific type or types of cellulose yarn or fiber included in the knit fabric material is generally not limited, though in some embodiments, the cellulose yarn or fiber is cotton. In some embodiments, the elastomeric or texturized yarn or fiber included in the surface layer is polyurethane yarn, such as spandex.

In some embodiments, the knit fabric material is from about 82 to about 98 wt. % non-elastomeric yarn or fiber, and from about 2 to about 18 wt. % elastomeric yarn or fiber. In some embodiments, the knit fibric material is from about 90 to about 97 wt. % non-elastomeric yarn or fiber, and from about 3 to about 10 wt. % elastomeric yarn or fiber. Providing a knit fabric material with an elastomeric yarn content in the about 2 to about 18 wt. % range, such as in the range of from about 3 to about 10 wt. %, provides the surface layer with the desired stretchability while minimizing the amount of elastomeric yarn content in the surface layer, which thereby minimizes the cost of the surface layer.

As noted previously, the surface layer 15 is a stretchable material such that during the process of forming surface features in the base layer 11 (and as described in greater detail below), the surface layer 15 stretches and conforms to the surface features as part of forming the surface features. In some embodiments, the surface layer 15 is stretchable in at least two directions and is made to stretch in more than one direction when the surface features are formed in the base layer 11. In some embodiments, when the surface features are formed in the base layer 11 and the surface layer 15 is stretched in multiple directions as a result, the molding process (or other process used for forming surface features) and surface layer are configured such that the stretch percentage of the surface layer 15 upon completion of the formation of the surface features is from about 30 to about 75%, such as about 62%. Stretch percentage is generally calculated by dividing the width of surface layer when stretched by the width of surface layer when unstretched, minus 1. For example, if the surface layer is stretched to a width of 16 mm and has a non-stretched width of 10 mm, then the stretch percentage can be calculated as ( 16/10)−1=0.6, this making the stretch percentage 60%.

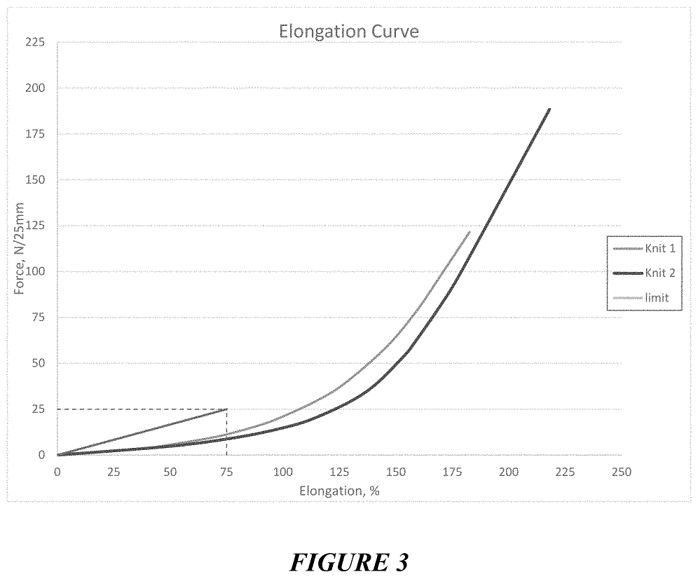

When stretching or otherwise elongating the surface layer within the percentage ranges described above, the stretching should be carried out at relatively low force. In some embodiments, stretching of the surface layer is carried out at no more than 25 N per 25 mm force. This limit is put in place at least in part to avoid instances where excessive base layer material (e.g., rubber) pushes through the knit surface layer during the process of forming surface features and/or the excessive force used to stretch the surface layer prevents or impedes formation of the surface features. FIG. 3 illustrates the elongation curve for surface layer materials having a composition in accordance with the embodiments described herein, and shows how the desired elongation percentages can be achieved at stretching forces no more than 25 N per 25 mm force, thus meaning that the desired elongation can be achieved without using a stretch force that may, e.g., negatively impact or impede the formation of surface features in the high efficiency belt described herein.

The manner in which the surface layer 15 is stretched during formation of the surface features as well as the selection of the initial (i.e., non-stretched) surface layer 15 itself may also be controlled such that upon formation of the surface features and the corresponding stretching of the surface layer 15, the surface density of the stretched surface layer 15 on the front surface of the base layer 11 is in the range of from about 90 to about 250 g/m², such as from about 100 to about 150 g/m². Providing a surface density in this range helps to ensure that the surface layer provides sufficient covering that provides good wet and dry noise performance without providing excessive covering that would result in too low COF on the belt.

As described previously, belt 10 may further include a backing layer 14. Any backing material suitable for use in belt construction can be used. Similarly, the thickness of the backing material is not limited and may be adjusted based on the desired thickness for the backing layer 14 of the resulting belt. In some embodiments, the backing material is a rubber material, though typically a rubber material different from the rubber material used in the base layer 11. In some embodiments, the backing material may include one or more of a textile, adhesion rubber, and the like. Preferably the thickness of the backing material is reduced as compared to traditional backing layer thicknesses.

As also described previously, belt 10 may further include a plurality of cords 12 embedded within the adhesion layer 13 proximate the interface between the adhesion layer 13 and base layer 11. The number, size, shape, and orientation of the cords 12 is generally not limited. The material of the cord 12 is generally not limited, and in some embodiments, may include metal, aramid, carbon fiber, nylon, polyester, glass, ceramic and various composite materials and may include hybrid mixtures of materials.

In some embodiments, belt 10 has an overall thickness that is less than the thickness of previously known conventional belts. For example, in some embodiments, belt 10 has a thickness in the range of from 2.6 mm and 4.2 mm, such as from about 3.0 to 3.8 mm or from about 3.2 to about 3.5 mm, while conventional belts typically have a thickness greater than 4.2 mm, such as 4.3 mm or greater. In some embodiments, this thickness reduction is due primarily to the height of the surface features (e.g., ribs) being shorter than in other previously known belts. In some embodiments, the height of the surface features is in the range of from 1.3 to 1.8 mm. While in other embodiments, belt 10 may have an overall thickness that is equal or greater than 4.3 mm, such as from 4.3 mm and 5 mm, or even greater than 5.0 mm.

While the belt 10 described previously and shown in FIG. 1 generally includes a belt having a backing layer/adhesion layer/cord/base material layer/surface layer construction, it should be appreciated that alternate belt constructions can also be used. For example, the adhesion layer 14 may be the same material as the base layer 11, in which case the adhesion layer 14 and the base layer may constitute a single layer, with cords 12 embedded therein.

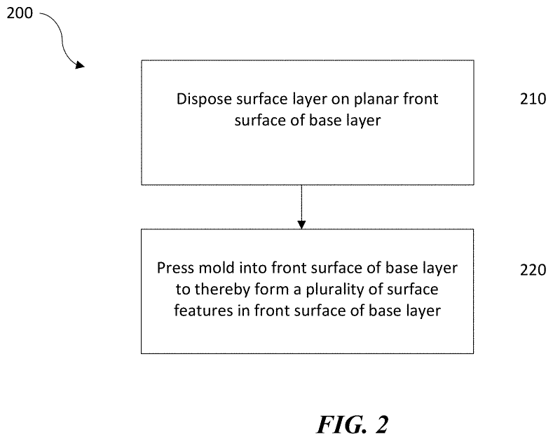

The belts of the invention may be manufactured according to known methods of making belts. For example, with reference to FIG. 2, a method 200 manufacturing a belt as described previously is illustrated. The method generally includes the step 210 of disposing a surface layer on a planar front surface of a base layer, and the step 220 of pressing a mold into the front surface of the base layer to thereby form a plurality of surface features in the front surface of the base layer. In step 220, the presence of the surface layer on top of the front surface of the base layer means that pressing a mold into the front surface of the base layer to form surface features therein also presses and stretches the surface layer. Variations on this method are also possible. For instances, in some instances, a technique, sometimes referred to as an upright build, may be used where the planar surface is opposite the mold.

In yet other embodiment, the various materials may be applied to a mandrel to build up the belt materials. A mandrel with a smooth cylindrical surface may be used to make the belts having one or both of the front and back surfaces smooth. A grooved or wavy mandrel may be used to build up and/or mold a belt embodiment that includes surface features such as ribs or grooves, as described above.

With respect to step 210, any manner of disposing the surface layer on a planar surface of the base layer. In some embodiments, the base layer is prepared according to conventional methods for preparing a base layer of a belt, such as mixing together the component ingredients of the base layer and then coating, pouring or otherwise disposing the mixture on a surface or in a mold to create a layer of the base material. Once prepared, the surface layer is disposed over the front surface of the base layer such that the surface layer covers a portion or all of the base layer. In some embodiments, the surface layer is a sheet of surface layer material that is cut to size such that it is approximately the same size as the base layer. In such embodiments, disposing the sheet of surface layer material on the base layer results in the sheet of surface layer material covering substantially all of the front surface of the base layer.

In some embodiments, prior to step 220, the edges of the surface layer disposed on the front surface of the base layer are secured By securing the surface layer (via any suitable means), the step 220 of pressing a mold into the base layer results in the surface layer desirably stretching as described in more detail below. In other embodiments, securing the edges of the surface layer may not be necessary, such as if some manner of adhesion between the surface layer and the front surface of the base layer is provided.

In step 220, a mold or similar pressing equipment is pressed into the front surface of the base layer in order to form surface features in the front surface of the base layer. The specific configuration, including shape, size and orientation of the mold is not limited, and is generally designed in order to provide whatever surface features are desired. For example, where the surface features to be formed in the base layer are ribs, the mold or pressing equipment has the shape, size, and orientation for forming ribs in the surface of the base layer.

The specific manner of carrying out the molding step is not limited, and any conventional means and equipment can generally be used. In some embodiments, the mold or press equipment includes applying some amount of heat to the base material to facilitate formation of the surface features in the front surface of the base layer. Full or partial curing of the base layer may occur during this step. In some embodiments, the base layer is only partially cured or left otherwise malleable such that the mold can shape surface features into the surface of the base layer.

In some embodiments, molding step 220 is carried out in a specific manner that accomplishes one or more of several desired outcomes. First, and as mentioned previously, the step 220 is carried out such that surface features are formed in the base layer. Furthermore, step 220 should be carried out such that the mold or other equipment pushes and stretches the surface layer into the surface features such that the surface layer conforms to the surface features. That is to say, the surface layer should directly abut the surface features formed in the base layer, with no gaps or spaces between the surface layer and the front surface of the base layer having surface features formed therein. This configuration is shown in FIG. 1, wherein surface layer 15 directly abuts base layer 11 throughout all of the surface features, including the valleys of each surface feature.

Step 220 is also carried out such that the mold or press equipment stretches to the surface layer until the surface density of the surface layer on the front surface of the base layer is in the range of from about 90 to about 250 g/m², such as from about 100 to about 150 g/m². The ability to achieve this surface density is dependent on several factors, including the initial surface density of the pre-stretched surface layer, the material of the surface layer and its stretchability, and the size and dimensions of the surface features formed in the base layer via application of the mold or pressing equipment. As such, all of these features need to be considered and designed together to ensure that upon completion of step 220, the desired stretching of the surface layer occurs such that the desired surface density of the surface layer is achieved. As noted previously, obtaining the desired surface density plays an important role in providing a belt that has the desired improved noise reduction while still providing the desired abrasion resistance and COF in both wet and dry conditions. For example, if the surface layer is over-stretched, in which case the surface density may be outside of the specified range, too much of the underlying base layer is exposed through the open knit of the surface layer, which may negatively impact the wear resistance and COF.

Step 220 should also be carried out in a manner where the surface layer is stretched in at least two directions. As described previously, the surface layer material is preferably a material that stretches in at least two directions. For example, the material may be oriented with either warp or weft parallel to the belt longitudinal axis. As such, in some instances the material can be stretched along the belt longitudinal axis and along the warp axis of the material, whereas, in other instances, the material can be stretched along the belt longitudinal axis and along the weft axis of the material. In other embodiments, the material can be stretched in off-axis directions. For example, the material can be stretched in a direction that is 45° from the belt longitudinal axis and 45° from the warp or weft axis. While the above example provides for stretching the material in directions that are 45° off-axis, the 45° is illustrative and non-limiting as the off-axis directions can be off-set any degree ranging from 1° to 179°. Thus, the molding or pressing step 220 should be carried out to take advantage of this multi-directional stretch and stretch the surface layer over the surface features in more than one direction.

In some embodiments, step 220 is also carried out in manner that ensures the surface layer is stretched to a desired range from its original length. For example, step 220 may be carried out such that the final surface layer on the base layer having surface features formed therein from the molding or pressing step has a stretch percentage of from about 30 to about 75%. As with achieving the desired surface density, achieving the desired stretch percentage may depend on a variety of factors, including but not limited to, the material of the surface layer and the dimensions, size and shape of the surface features formed in the base layer.

The manufacturing method described herein may include additional steps not described herein for simplicity's sake and due to the generally well-known techniques used to carry out such steps. For example, the method described herein may be preceded by additional steps used for providing the other components of the belt, such as the backing layer, the adhesion layer, and the cords. Generally speaking, such steps include providing the backing layer, disposing the adhesion layer on the backing layer, winding cords around the adhesion layer, and then disposing the base layer on the adhesion layer and cords as described in detail above. Additional details on these steps can be found in U.S. Patent Application Publication No. 2021/0062892, previously incorporated by reference herein.

### EXAMPLES

### Example 1

A belt is prepared as described herein to thereby provide a belt having the configuration generally shown in FIG. 1. The composition of the surface layer material is 95 wt. % cotton and 5 wt. % spandex. COF and noise tests are carried out on a new and conditioned version of the belt. The conditioning involves 60 hours of high temperature durability stress test on the belt sample. Table 1 below summarizes the data obtained from the testing.

TABLE 1

| Belt (95 wt. % cotton, | | | |
|---|---|---|---|
| 5 wt. % spandex) | COF (dry) | COF (wet) | Misalignment Noise |
| New | 0.92 | 0.96 | None (all quiet) |
| Conditioned (60 hrs) | 1.28 | 1.04 | None (all quiet) |

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. A belt, comprising:
a base layer having a back surface and a front surface opposite the back surface, wherein the front surface is in the form of a plurality of surface features; and
a stretched surface layer disposed on the front surface of the base layer, the stretched surface layer conforming to the surface features;
wherein the stretched surface layer comprises a knit fabric material, the knit fabric material comprising:
from about 3 to about 10 wt. % elastomeric fiber or yarn; and
from about 90 to about 97 wt. % non-elastomeric fiber or yarn; and
wherein the stretched surface layer is stretched over the front surface of the base layer such that the surface density of the stretched surface layer on the front surface is from about 100 to about 150 g/m².

2. The belt of claim 1, wherein the stretch percentage of the stretched surface layer is from about 30 to about 75%.

3. The belt of claim 1, wherein the thickness of the belt is in the range of from about 3.0 to 3.8 mm.

4. The belt of claim 1, wherein the surface features are ribs or teeth.

5. The belt of claim 1, wherein the non-elastomeric yarn or fiber comprises cellulose-based yarn or fiber and the cellulose-based yarn or fiber comprises cotton yarn or fiber.

6. The belt of claim 1, wherein the stretched surface layer is stretched on the front surface in at least two directions.

7. The belt of claim 1, further comprising:
an adhesive layer having a front surface and a back surface opposite the front surface, the front surface of the adhesive layer abutting the back surface of the base layer;
a plurality of cords embedded in the adhesive layer and located proximate the interface between the adhesive layer and the base layer; and
a backing layer, the backing layer abutting the back surface of the adhesive layer.

8. The belt of claim 1, wherein the base layer comprises a rubber material.

9. The belt of claim 1, wherein the elastomeric fiber or yarn is a polyurethane fiber or yarn.

10. The belt of claim 1, wherein the height of the surface features is less than 1.8 mm.

11. A method of manufacturing a belt, the method comprising:
disposing a surface layer on a planar front surface of a base layer; and
pressing a mold into the front surface of the base layer to thereby form a plurality of surface features in the front surface of the base layer, wherein pressing the mold into the front surface of the base layer is carried out such that:
the surface layer is stretched to conform to the surface features formed in the front surface of the base layer;
the surface layer is stretched such that the surface density of the surface layer of the front surface is in the range of from about 100 to about 250 g/m²; and
the surface layer is stretched in at least two directions.

12. The method of claim 11, wherein the surface layer is disposed on the front surface of the base layer such that the entire front surface of the base layer is covered by the surface layer.

13. The method of claim 11, wherein the surface layer comprises a knit fabric material, the knit fabric material comprising:
from about 3 to about 10 wt. % elastomeric fiber or yarn; and
from about 90 to about 97 wt. % non-elastomeric fiber or yarn.

14. The method of claim 13, wherein the non-elastomeric fiber or yarn comprises a cellulose-based yarn or fiber, and the cellulose-based fiber or yarn comprises cotton yarn or fiber.

15. The method of claim 11, wherein the elastomeric fiber or yarn is a polyurethane fiber or yarn.

16. The method of claim 11, wherein pressing the mold into the front surface of the base layer is carried out such that the surface layer is stretched to a stretch percentage of about 30 to 75% and the stretching force does not exceed 25 N per 25 mm.

17. The method of claim 11, wherein the surface features formed by pressing the mold into the front surface of the base layer have a height less than about 1.8 mm.

18. The method of claim 11, wherein the surface features are ribs or teeth.

19. The method of claim 11, wherein the surface layer disposed on the front surface of the base layer is in the form of a sheet.

20. The method of claim 11, wherein the base layer comprises a rubber material.
